(19) United States
(12) Patent Application Publication
(10) Pub. No.: US 2016/0055376 A1
(43) Pub. Date: Feb. 25, 2016

(54) METHOD AND SYSTEM FOR IDENTIFICATION AND EXTRACTION OF DATA FROM STRUCTURED DOCUMENTS

(71) Applicant: iQG DBA iQGATEWAY llc, The Woodlands, TX (US)

(72) Inventor: PRAVEEN KODURU, The Woodlands, TX (US)

(73) Assignee: iQG DBA iQGATEWAY LLC, THE WOODLANDS, TX (US)

(21) Appl. No.: 14/741,859

(22) Filed: Jun. 17, 2015

Related U.S. Application Data
(60) Provisional application No. 62/015,410, filed on Jun. 21, 2014.

(51) Int. Cl. G06K 9/00; G06K 9/46; G06F 17/27

(52) U.S. Cl. CPC G06K 9/00463; G06F 17/2765; G06K 9/4604; G06K 2209/01

(57) ABSTRACT

The various embodiments herein provide a method and system for identifying and extracting data from electronic documents. The method comprises of extracting text from scanned documents with location on page data using OCR technology, identifying one or more tables present in a page using patterns in text placement in rows and columns, identifying the table boundaries using a pattern recognition method, identifying table borders using the location on page data, identifying the rows and columns on the table based on the identified table borders, defining a table structure for data extraction and automatically extracting data from cells of the table formed by identified rows and columns.

### FIELD OF TECHNOLOGY

The present disclosure generally relates to document management systems and methods and particularly relates to a method and system for extracting structured data in electronic documents using Optical Character Recognition (OCR).

### BACKGROUND

The exchange of different data forms between users using the conventional techniques is a day-to-day challenge in business operations. A number of conventional techniques have been proposed for obtaining data stored in a database by reading a document such as a text document, a photograph or the like using a scanner, or document data electronically created using a personal computer (PC), and extracting document data corresponding to the document read from the database. It would be ideal to have the data in the forms readily available for person to person communication using database interconnects. This becomes a practical challenge in most cases with complex forms as in invoices, order forms and access privileges, forcing manual extraction and populating a database to enable management of information by the end user.

The existing methods generally use OCR technology to automate the process of extracting the content from an electronic document. However, most of the current OCR solutions for content recognition and extraction, transform only a pixel-by-pixel based location of the data to an excel sheet or word document for further editing. This does not facilitate the end users need for automatic query and retrieval of the content based on context. Further the existing methodologies necessitate manual intervention to identify the field where the value is listed and then extract the value for further processing.

Other automated approaches of content extraction from complex documents via OCR involve a cumbersome initial setup and associated overheads. The existing OCR techniques typically do not perform any metadata extraction. Also the quality of OCR output is not always perfect as some words do not get recognized correctly. Also the conventional OCR techniques are usually not able to detect different formats and sequences of data. Further the existing methods necessitates training samples or templates similar to the documents to be processed to be pre-defined and the recognition engine trained by the user for learning the type and location of various fields.

In view of the foregoing, there is a need to provide a method and system for identifying and extracting content from various data forms with minimal manual intervention.

The above mentioned shortcomings, disadvantages and problems are addressed herein and which will be understood by reading and studying the following specification.

### SUMMARY

The primary objective of the embodiments herein is to provide a method and system for identifying and extracting data from a structured electronic document with minimal human intervention.

Another objective of the embodiments herein is to provide a method and system for replicating the data extraction on identified similar templates without providing any additional inputs or training samples.

Another objective of the embodiments herein is to provide a method and system for allowing the extracted contents to be stored in a database and to be made available for the end user to query on extracted fields from processed documents.

The various embodiments herein provide a method and system for identification and extraction of structured data from electronic documents. The method involves automatic querying and retrieving contents from the extracted structured data of the electronic document. The electronic document herein refers to, but not limited to, a scanned document. The structured data may be, but not limited to, field names, row names and column names from tables present in the document.

According to an embodiment herein, the method of automatic querying and retrieving contents from the extracted structured data comprises of scanning the document for bounding boxes around each letter and then combining the close bounding boxes without spaces to form larger bounding boxes for words (or phrases). Similar phrases with similar geometrical patterns are then align checked both vertically and horizontally to form a list of associated variables. The top item in the list is considered as the header or field name and then following consecutive fields as field values. The patterns are then utilized in automatic recognition mode to perform an automatic recognition of a bounded table region, header item and the related table data for each of the header field identified in the bounded table region.

By analyzing similar location patterns of phrases and localized values in a given input form, the geometrical analytic method herein analyzes the location data for each of the boxes and finds the largest grouping of variables that have a similar pattern. Further this region is marked as an approximation of a possible table. Similarly, all such possible large groupings are identified as tables are marked. Within each table, the leading groups of similar values are then marked as header fields or variable names and the trailing data following the header field is associated with the header field as the related data.

According to an embodiment herein, the method and system herein provides for identifying content from various types of data forms and extract user specified fields for query and retrieval without necessitating any prior training or setup overheads. Additionally, the extracted content is made available for the end user to query any field embedded in the table, for example, Invoice No., Total, Billing Address, etc. with no prior training and on-demand.

According to an embodiment herein, the method herein uses image analytics which employs advanced data mining techniques and emulated the function of parsing a scanned document and identifying the table headers, columns, borders, etc. The embodiments herein provides for accurately identifying and parsing contents of varied formats of text and tabular forms with minimal human intervention.

According to an embodiment herein, the method comprises of extracting structured data in a field-based format from electronic documents, recognizing bounding boxes based on header search, querying structure data based on desired information extraction parameters, extracting the queried structure data based on desired information extraction parameters and representing the extracted structured data.

According to an embodiment herein, the method employs a spatial pattern recognition which enables open information extraction for query and retrieval of data stored in the document.

According to an embodiment herein, the method herein automatically identifies and parses content in a document and generates a schema of field names and related data via spatial pattern recognition of document. The spatial pattern recognition technology herein provides the ability to access information presented in tabular and columnar formats by incorporating a combination of analytical methods for mixed-initiative (semi-interactive) estimation of table boundaries. The method herein further uses constraints provided by the user and produces additional constraints that are also pertinent to recognition of bounding boxes for formatted data, including row and column. The method herein also permits users to specify desired information extraction parameters by providing partial header information and editing geometric constraints within a graphical user interface.

According to an embodiment herein, the information extraction parameters comprises of partial header field's information, table data alignment direction or geometric bounding constraints that can be considered as parameters utilized for identifying tables and its corresponding data. Generally, during the automatic content recognition of the document, the data embodied in the document is automatically extraction. In case of a user input, the embodiments herein then modify the data extraction or parsing the output to the selected tables or location as defined by the user or according to user requirements.

According to an exemplary embodiment herein, the method and system herein enables the users to extract tables from scanned documents, extract data from the tables such as column names, row values and the like. Further, the method and system identifies content from various types of document forms and extract data from user specified fields.

The embodiments herein enable the users to specify desired information extraction parameters by providing partial header information and editing geometric constraints within a graphical user interface. Further, the embodiments herein provide for controlling over feature analysis components and methods to be used.

The embodiments herein provide the user with needed flexibility in handling varying complexity of data forms that are possible in real world scenarios without having to search for another alternative. For example, the method herein provide appropriate alternatives for automatic recognition of content in the provided documents, modifying/updating the parameters utilized to make appropriate amends to the automatic extracted content by minimal user intervention, completely overriding the above approaches and providing the user to do a manual definition of data content followed by extraction. By providing the user a choice of the various feature analysis components based approaches that are either automatic or semi-automatic or manual approaches, all in one tool enables the users to manage difficult scenarios with ease.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram of a document data extraction system, according to an embodiment herein.

FIG. 2 is an exemplary illustration of a user interface for selecting a scanned document for data extraction, according to an embodiment herein.

FIG. 3 is an exemplary illustration showing an identified table in a sample document along with the columns, according to an embodiment herein.

FIG. 4 shows the user interface displaying the identified table in FIG. 2, with row names (in bold) and values extracted from the table for each field, according to an embodiment herein.

FIG. 5 shows the user interface to process multiple documents as a batch process using predefined settings, according to an embodiment herein.

FIG. 6A shows the sample of data extracted stored in simple text allowing for easy query and retrieval based on field name and document identifier from multi page document, according to an embodiment herein.

FIG. 6B shows the sample of data extracted stored in XML allowing for easy query and retrieval based on field name and document identifier, according to an embodiment herein.

FIG. 7 is a flowchart illustrating a method of extracting data from a scanned document, according to an embodiment herein.

Although specific features of the present invention are shown in some drawings and not in others. This is done for convenience only as each feature may be combined with any or all of the other features in accordance with the present invention.

### DETAILED DESCRIPTION OF THE EMBODIMENTS

The present invention provides a method and system for extraction of structured data from electronic documents, including scanned documents. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The method of automatic querying and retrieving contents from the extracted structured data comprises of scanning the document for bounding boxes around each letter and then combining the close bounding boxes without spaces to form larger bounding boxes for words (or phrases). Similar phrases with similar geometrical patterns are then align checked both vertically and horizontally to form a list of associated variables. The top item in the list is considered as the header or field name and then following consecutive fields as field values. The patterns are then utilized in automatic recognition mode to perform an automatic recognition of a bounded table region, header item and the related table data for each of the header field identified in the bounded table region.

The data extraction method and system herein increases the degree of automation in document processing and the precision and recall of extracted values. The method and system herein provides the ability to access the information presented in tabular and columnar formats by incorporating a combination of analytical for mixed-initiative (semi-interactive) estimation of table boundaries. The embodiments herein uses constraints provided by the user and produces additional constraints that are also pertinent to recognition of bounding boxes for formatted data, including row and column boundaries. The embodiments herein enable the users to specify desired information extraction parameters by providing partial header information and editing geometric constraints within a graphical user interface. Additionally the embodiments herein provide for controlling over feature analysis components and methods to be used.

According to an embodiment herein, the user can provide a partial field name of a field item listed in the table as column title. The method herein then marks the table which has a matching field name in the table columns data as the user requested table and return the data for that particular table. In this case, the user is not required to specifically mention where the table resides in the page or what are the dimensions of the table to be extracted. Also if the template or structure of the data form changes, the embodiments herein need not be modified, as the only input from the user was a partial field name provided and the embodiments herein update the tables on a new template and provide the parsed output appropriately. Additionally in situations such as complex forms where a lot of data is present to reduce processing time, the user may mark region of document to only scan and identify tables or necessary data to be extracted.

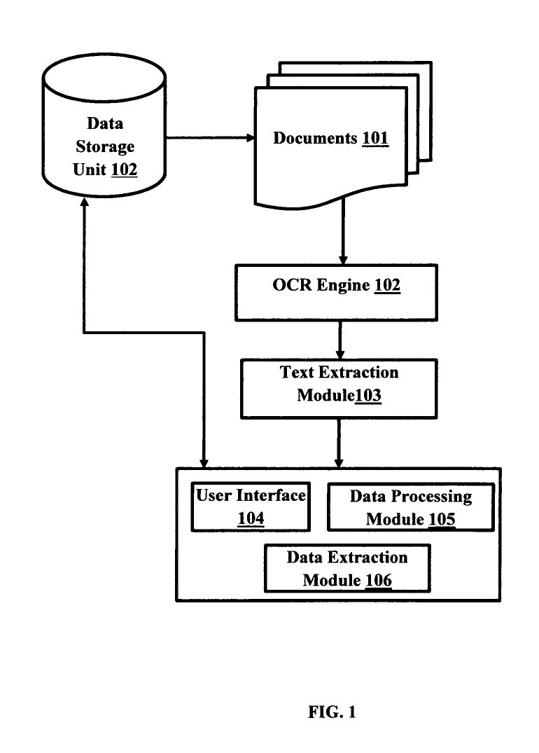

FIG. 1 is a block diagram of a document data extraction system, according to an embodiment herein. As shown in FIG. 1, the document data extraction system extracts a plurality of documents 101 from a data storage unit 102. The plurality of documents 101 is in the form of either one or more physical sheets of paper, or a digital file containing images of one or more sheets of paper. The digital file can be in one of many formats, such as PDF, TIFF, BMP, or JPEG. The system employs image processing techniques on the document to segment the document image and to isolate potential content areas. The documents 101 are then provided to an OCR engine 102 which produces a text output. Further the OCR recognized text is inputted to the text extraction module 103, which extracts text from scanned documents with location on page data. The extracted text is then passed to a data processing module 105 through a user interface 104. The data processing module 105 is adapted for identifying tables in a page using patterns in text placement in rows and columns, identifying the boundaries and edges of tables using pattern recognition methods and identifying table borders using page information on location and defines a data structure for extraction after table borders, rows and columns are identified. Further, the data extraction module 106 enables the user interface 104 for data extraction and validation. The data herein refers to data from tables such as column names, row values and the like.

The user interface 104 herein enables the user to toggle several data extraction settings and make adjustments on the extraction results. For example, the users can make adjustments like merging cells, deleting cells and editing content of the cell. Furthermore, the user interface also enables auto cell content spell checking and correction using approximate string matching. On the table level, the users can use the drawing tool to specify the table boundaries and headers; delete or add tables and edit tables. Such specifications can be stored in a settings file and loaded later for processing similar documents as required.

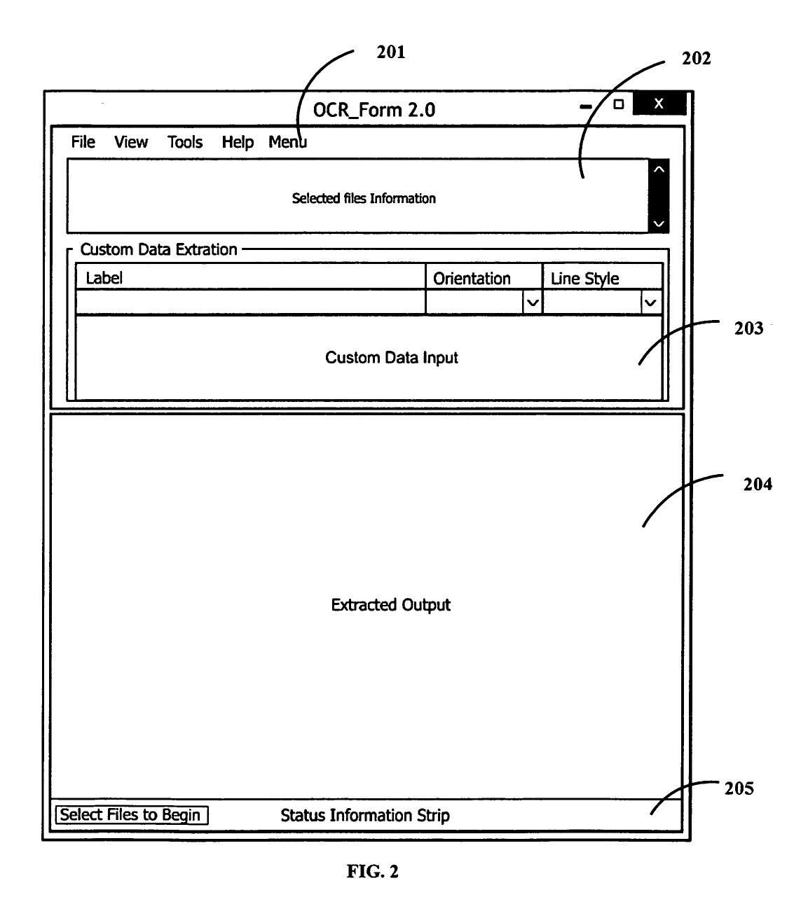

FIG. 2 is an exemplary illustration of a user interface for selecting a scanned document for data extraction, according to an embodiment herein. The user interface as shown in FIG. 2 comprises a menu tab 201, a selected file information tab 202, a custom data input tab 203, an extracted output tab 204 and a status information strip 205. The menu tab 201 is adapted for supporting all types of operations. The selected file information tab 202 displays the file paths of all the files being selected by the user at one time. The custom data input tab 203 enables configurations to extract user requested data. The extracted output tab 204 displays all the data being extracted in a plain text format. Further the status information strip 205 provides information on the status of the data extraction.

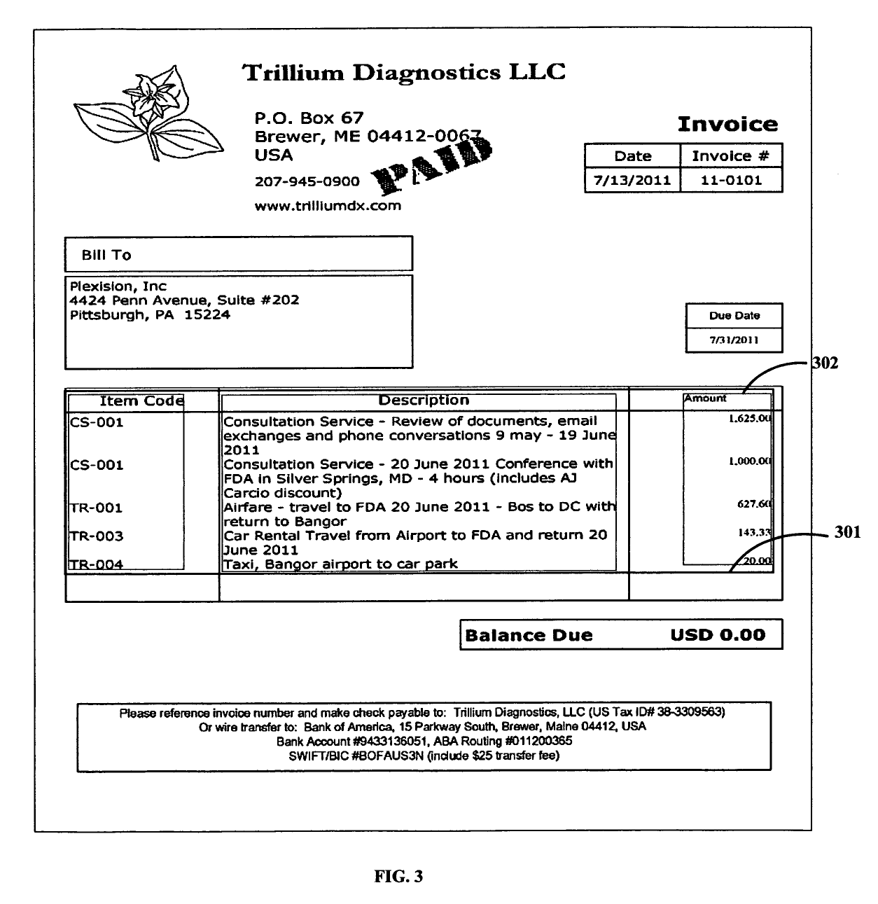

FIG. 3 is an exemplary illustration showing an identified table in a sample document along with the columns, according to an embodiment herein. The table 301 in the sample document is identified using patterns in text placement in the document. Further, table boundaries and table borders are identified using location on page information. After the table borders are identified, the columns 302 in the table are identified for data extraction.

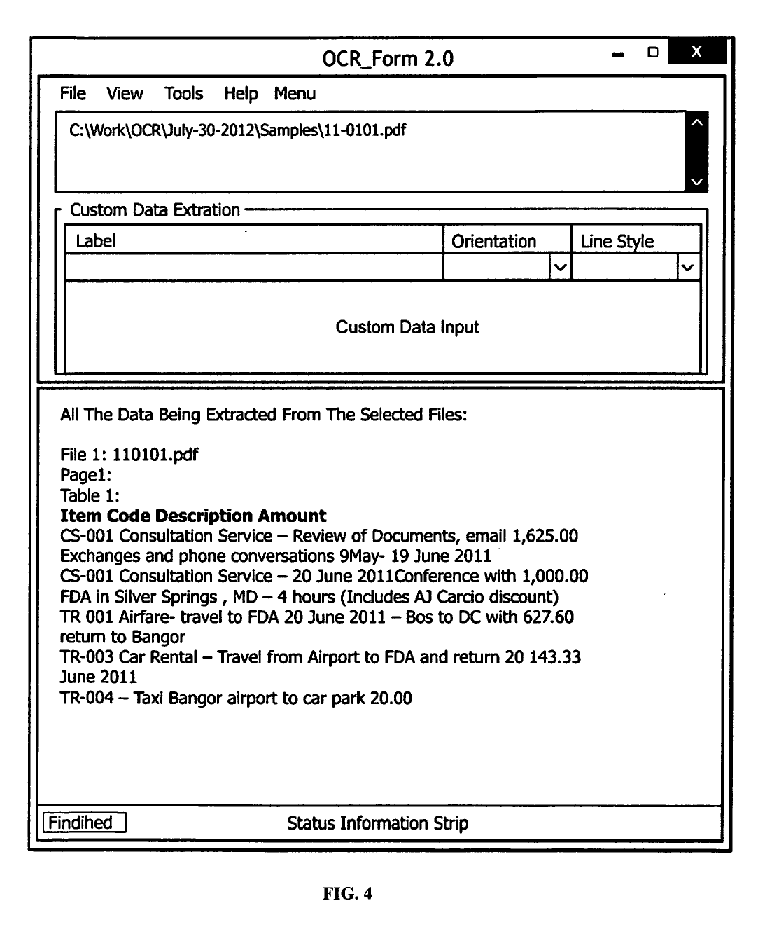

FIG. 4 shows the user interface displaying an output of the automatic content recognition procedure, according to an embodiment herein. The top part shows the file name that is used for data extraction. The next box shows the preview of the extracted content. The fields include file name from which the data is extracted, followed by the table data that was extracted. The bold text indicates the field names or column header, which is then followed by values for each of the different rows in different lines. Here the fields are separated by a space-delimited format. The bottom block is a status indicator which indicates the status of data extraction process for a particular stage.

According to an embodiment herein, the user interface herein shows a list of multiple files if data extraction is done as a batch process over multiple files. This view is more of a preview of extracted content for quick analysis and adaptation of input parameters by the user.

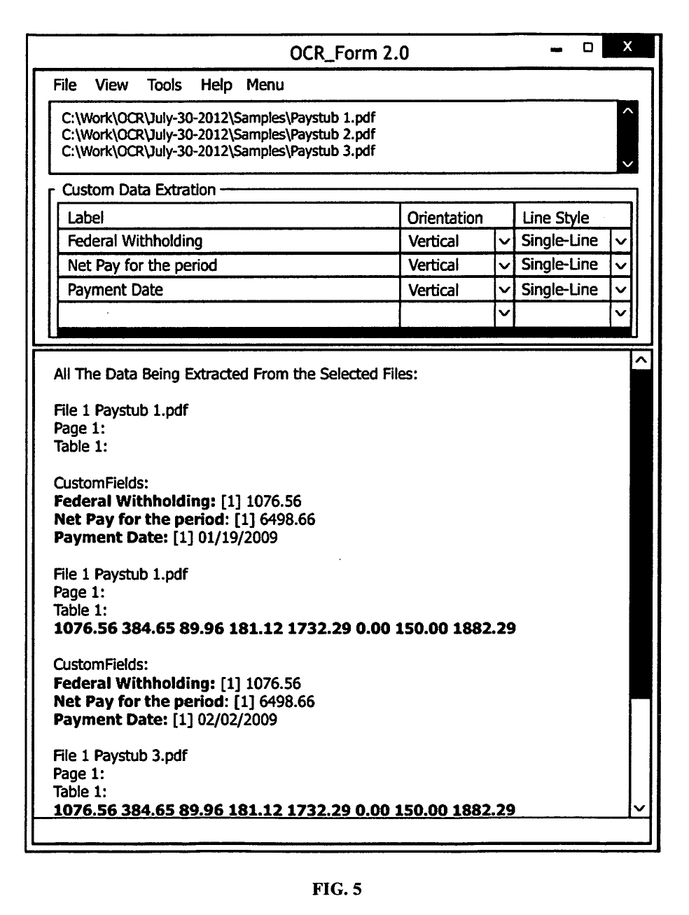

FIG. 5 shows the user interface to process multiple documents as a batch process using predefined settings, according to an embodiment herein. In this embodiment, the user has requested for specific fields from the table, in addition to the identified table data. The top part shows the multiple files that are selected for a batch process operation and the output window shows the preview of the fields extracted from each file one after the other in the order of processing.

The main table that has been automatically identified is shown with the table names and values denoted under Table 1: section in the output preview window. As shown in the exemplary illustration herein, the user has requested additional fields to be extracted from the input form with partial information such as “Federal Withholding” and the data field to be extracted is to be searched under “vertical” orientation of form where the named variable is found on the document. Some of these fields are mentioned in the “Custom data extraction” section of the user interface and these extracted values are then shown in the output preview window under the “Custom fields” section with the field name and the extracted value.

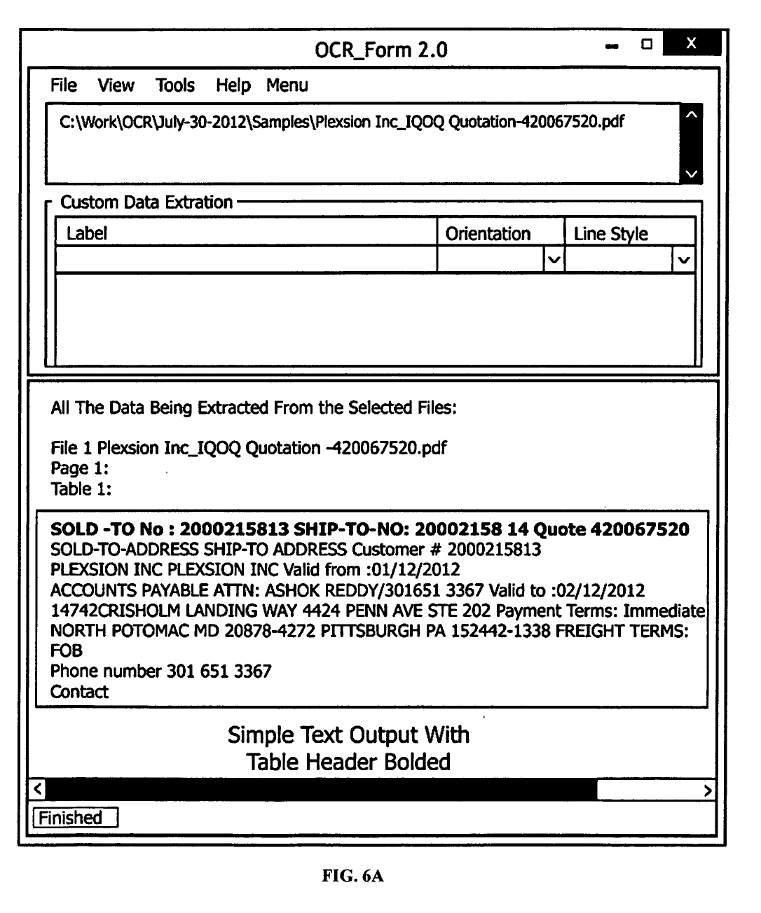

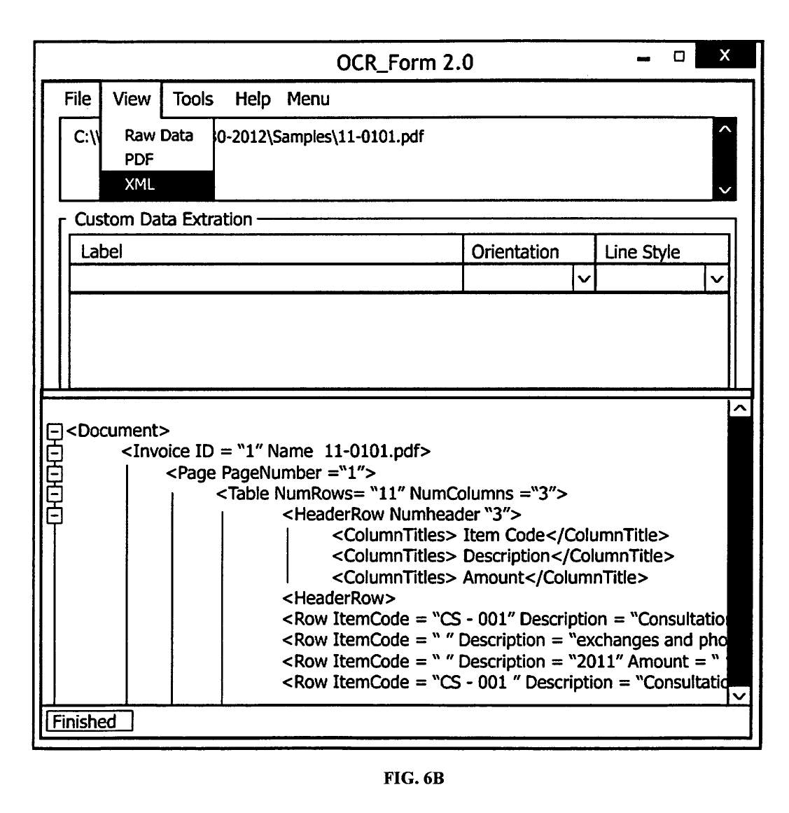

FIG. 6A shows the sample of data extracted stored in simple text allowing for easy query and retrieval based on field name and document identifier, according to an embodiment herein.

FIG. 6B shows the sample of data extracted stored in XML allowing for easy query and retrieval based on field name and document identifier, according to an embodiment herein. The text which is provided in bold corresponds to the table contents and the un-bolded sections are the XML tags.

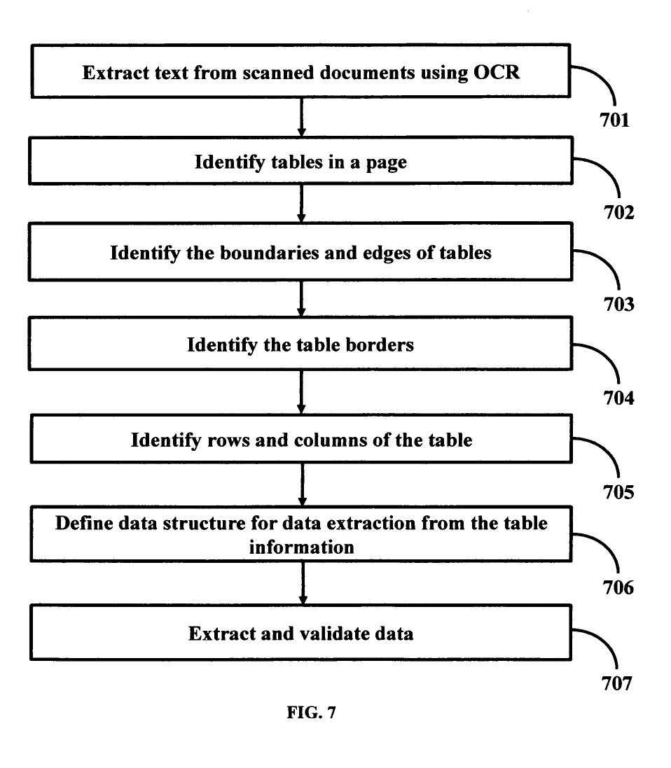

FIG. 7 is a flowchart illustrating a method of extracting data from a scanned document, according to an embodiment herein. At step 701, extract test from scanned documents with location on page data using OCR. At step 702, identify the tables in a page using patterns in text placement in rows and columns. Further at step 703, the boundaries and edges of the identified tables are determined using pattern recognition methods. At step 704, the borders of the identified tables are determined based on the location on page information. After the tables are identified, the rows and columns in the table are identified at 705. At 706, define a data structure for data extraction from the table. At 707, extract the data from the tables and perform data validation of the extracted data.

According to an embodiment herein, the terminology word herein refers to a word recognized by the OCR engine; a cell is a unit which contains a plurality of words, line refers to a line in a page, where a line contains multiple cells, a block is an intermediate structure to cluster cells for table extraction, a row refers to a row in a table, a column refers to a column in a table, a page contains tables and multiple lines in non-tabular structures.

According to an embodiment herein, the data extraction after OCR step of extracting letters and location can be detailed as follows. The data extracted by the OCR engine is preprocessed and cleaned up for any errors during extraction and alignment of the document. Further the extracted words are identified and sorted into various lines as appropriately by page location; merging the words to form cells based on the spacing between the various cells, merging cells into groups of lines based on horizontal or vertical overlap of words, build blocks using a cluster of cells that are close enough on page layout to form a block, combine the obtained blocks to form all possible tables on the page and identify the grouping of the different elements of data items related to the table such as column names, values and boundaries. If any user modified input is provided, then use the specified parameters to update the extracted output and re-evaluate the table structure.

According to an embodiment herein, the user can provide a partial field name of a field item listed in the table as column title. The method herein then marks the table which has a matching field name in the table columns data as the user requested table and return the data for that particular table. In this case, the user is not required to specifically mention where the table resides in the page or what are the dimensions of the table to be extracted. Also if the template or structure of the form changes, the embodiments herein need not be modified, as the only input from the user was a partial field name provided and the embodiments herein update the tables on a new template and provide the parsed output appropriately. Additionally in situations such as complex forms where a lot of data is present to reduce processing time, the user may mark region of document to only scan and identify tables or necessary data to be extracted.

The embodiments of the present disclosure do not necessitate any prior training for OCR engine for content identification. Further the embodiments herein provides for automated content extraction, batch processing, content transfer to database or XML, query enabled data extraction, customization for complex forms, automated table recognition and the like.

The data extraction according to the embodiments herein eliminates the human labor and its accompanying requirements of education, domain expertise, training, software knowledge and/or cultural understanding, minimizes the time spent entering and quality checking the data, minimizes errors, protects the privacy of the owners of the data without being dependent on the security systems of data extraction organizations and eliminates the cost for significant up-front engineering efforts.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A method of extracting structured data from an electronic document, the method comprising steps of:
extracting text from the electronic document along with a position information of the text on a page;
identifying one or more tables present in the page; and
identifying contents in the one or more tables; wherein identifying contents in the one or more tables comprises of:
identifying boundaries and edges of the one or more tables using a spatial pattern recognition method;
identifying table borders using the position information of the text,
identifying one or more rows and columns of the table based on the identified table borders,
defining a data structure for data extraction; and
extracting structured data from a plurality of cells formed by the identified one or more rows and columns in the table.

2. The method of claim 1, wherein the electronic document is at least one of a scanned document in a Portable Document Format (PDF) file.

3. The method of claim 1, wherein the text is extracted from scanned documents using an Optical Character Recognition (OCR) Technology.

4. The method of claim 1, wherein the structured data comprises at least one of field names, column names and row data from the one or more tables present in the electronic document.

5. The method of claim 1, wherein extracting text from the electronic documents comprises of:
identifying a location and position of each letter on the page;
merging a plurality of identified letters to form words;
creating the plurality of cells by combining one or more words that are spaced within a predefined threshold;
creating one or more blocks by combining the plurality of cells adjacent to each other; and
combining the one or more blocks to identify the tables.

6. A system for extracting structured data from an electronic document, the system comprises of:
a text extraction module adapted for:
extracting text from the electronic document along with a position information of the text on a page;
a data processing module adapted for:
identifying one or more tables present in the page; and
identifying boundaries and edges of the one or more tables using a spatial pattern recognition method;
identifying table borders using the position information of the text,
identifying one or more rows and columns of the table based on the identified table borders,
defining a data structure for data extraction; and
a data extraction module adapted for:
extracting structured data from a plurality of cells formed by the identified one or more rows and columns in the table.

7. The system of claim 6, wherein the electronic document is at least one of a scanned document in a digital file in one of many formats such as PDF, TIFF, PNG, BMP or JPEG.

8. The system of claim 6, further comprising an Optical Character Recognition (OCR)
Engine adapted for:
converting the electronic document into a text output.

9. The system of claim 6, wherein the structured data comprises at least one of field names, column names and row data from the one or more tables present in the electronic document.

10. The system of claim 6, wherein the text extraction module is further adapted for:
identifying a location and position of each letter on the page;
merging a plurality of identified letters to form words;
creating the plurality of cells by combining one or more words that are spaced within a predefined threshold;
creating one or more blocks by combining the plurality of cells adjacent to each other; and
combining the one or more blocks to identify the tables.

11. One or more computer-readable media having computer-usable instructions stored thereon for performing a method for extracting structured data from an electronic document, the method comprising:
extracting text from the electronic document along with a position information of the text on a page;
identifying one or more tables present in the page; and
identifying contents in the one or more tables; wherein identifying contents in the one or more tables comprises of:
identifying boundaries and edges of the one or more tables using a spatial pattern recognition method;
identifying table borders using the position information of the text,
identifying one or more rows and columns of the table based on the identified table borders,
defining a data structure for data extraction; and
extracting structured data from a plurality of cells formed by the identified one or more rows and columns in the table.

12. The computer readable media of claim 11, wherein the structured data comprises at least one of field names, column names and row data from the one or more tables present in the electronic document.
